(19) United States
(12) Patent Application Publication
(10) Pub. No.: US 2003/0063743 A1
(43) Pub. Date: Apr. 3, 2003

(54) Device and method for increasing the reliability and constancy of a noise source

(76) Inventor: Norbert Janssen, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/252,451

(22) Filed: Sep. 23, 2002

Related U.S. Application Data
(63) Continuation of application No. PCT/DE01/00694, filed on Feb. 22, 2001.

(30) Foreign Application Priority Data
Mar. 23, 2000 (EP) 00 106 327.0

(51) Int. Cl. H04L 9/00

(52) U.S. Cl. 380/46

(57) ABSTRACT

An entropy memory and/or a one-way function are connected directly to the output of a physical noise source in order to increase the operating reliability and constancy of the physical noise source.

### CROSS-REFERENCE TO RELATED APPLICATION

This application is a continuation of copending International Application No. PCT/DE01/00694, filed Feb. 22, 2001, which designated the United States and was not published in English.

### BACKGROUND OF THE INVENTION

Field of the Invention

The present invention relates to a device and a method for increasing the reliability and constancy of a noise source. In many cases, cryptography techniques require random numbers. Random numbers are generated by digitizing the output signal of a source of white noise, for instance.

A possible attack against such a security system can begin at the physical noise source.

If the quality of a physical noise source deteriorates as a result of the physical attacks of an attacker, the security of the overall system is endangered.

Besides this, the known physical noise sources undergo sharp fluctuations in performance as a result of fluctuations in the fabrication technology.

### SUMMARY OF THE INVENTION

It is accordingly an object of the invention to be able to avert a physical attack by an attacker against a physical noise source over a defined time period.

It is an additional object of the invention to set the performance of a noise source to a constant value without degrading the quality of the noise data.

There are no solutions to these problems found in the prior art. The objects of the invention are inventively achieved in that an entropy memory is connected to the output of the noise source on the downstream side, or that the output values of the noise source are buffered.

A feedback shift register is particularly suitable as the entropy memory.

In order to further complicate an attack on the noise source, a one-way function can be connected to the entropy memory on the downstream side. The output values of the noise source are advantageously converted using a mathematical one-way function subsequent to being buffered in the entropy memory.

A cryptographic hash function is particularly well suited as the one-way function.

This one-way function is advantageously constructed as a hardwired circuit, because only in this way can an attacker be prevented from accessing the output of the noise source and the output of the entropy memory.

In order to achieve a constant performance of the noise source, it is particularly advantageous when the entropy memory is read with a constant frequency which is lower than the performance of the noise source. The output values of the noise source which are buffered in the entropy memory are thus processed with a constant clock cycle which is lower than the performance of the noise source.

The output values of the noise source and the entropy memory must not be accessed.

With the foregoing and other objects in view there is provided, in accordance with the invention, a device for increasing an operating reliability and constancy of a noise source having an output. The device includes: an entropy memory for connection to the output of the noise source, the entropy memory having an output; and a hard-wired one-way function connected directly to the output of the entropy memory.

In accordance with an added feature of the invention, the entropy memory is a feedback shift register.

In accordance with an additional feature of the invention, the one-way function is a cryptographic hash function.

In accordance with another feature of the invention, the noise source has a performance; and the entropy memory is read with a constant frequency that is lower than the performance of the noise source.

With the foregoing and other objects in view there is provided, in accordance with the invention, a method for increasing an operating reliability and constancy of a noise source. The method includes steps of: buffering output values of the noise source to obtain buffered output values; and immediately following the buffering, converting the buffered output values of the noise source using a hard-wired mathematical one-way function.

In accordance with an added mode of the invention, a feedback shift register is used to perform the buffering of the output values of the noise source.

In accordance with an additional mode of the invention, a cryptographic hash function is used as the one-way function.

In accordance with another mode of the invention, the method includes: further processing the buffered output values of the noise source at a constant clock cycle that is lower than a performance of the noise source.

In accordance with a further mode of the invention, the output values of the noise source cannot be externally accessed.

Other features which are considered as characteristic for the invention are set forth in the appended claims.

Although the invention is illustrated and described herein as embodied in a device and method for increasing the reliability and constancy of a noise source, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram showing a physical noise source that is protected by an entropy memory and a one-way function; and

FIG. 2 is a block diagram showing how a constant performance of the physical noise source can be obtained by clocking the entropy memory with a desired frequency.

### DESCRIPTION OF THE PREFERRED EMBODIMENTS

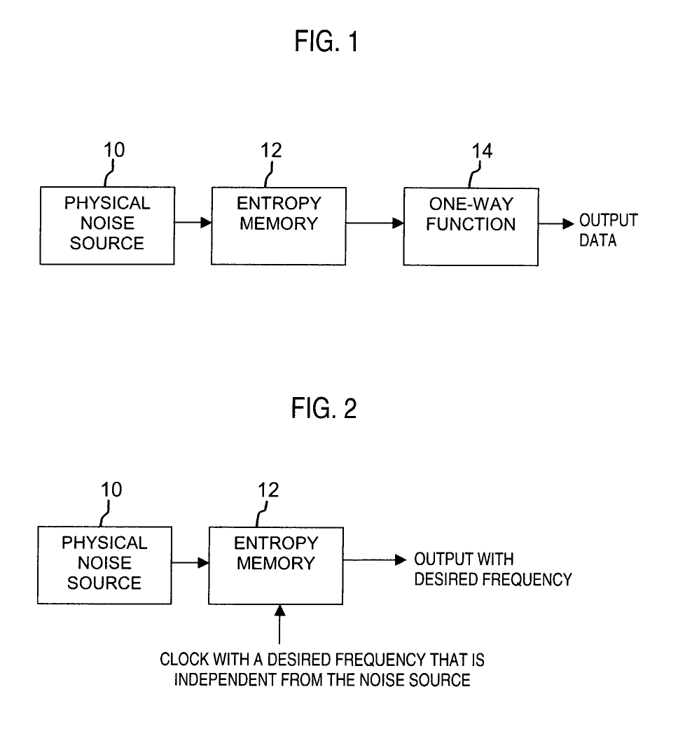

Referring now to the figures of the drawing in detail and first, particularly, to FIG. 1 thereof, there is shown a physical noise source 10 connected to a downstream entropy memory 12. A physical attack performed by an attacker on a physical noise source 10 over a defined period can be averted by connecting the downstream entropy memory 12 to the noise source, which is an ideal noise source prior to the attack.

The function of the entropy memory will now be described. Entropy refers to the information content of a volume of data, for instance a bit stream, which represents the output data of a random number generator. The following equation always applies:

0<entropy≦1.

Entropy is often measured as a percentage. Hence:

0%<entropy [%]<100%.

For instance, if the entropy of a data volume has the value 80%, then the data volume can be compressed by 100%−80%=20%. When the data is compressed by 20%, the data no longer have any redundancy and therefore have an entropy of 100%. Thus, the entropy can be increased by compression, in particular. An LFSR (Linear Feedback Shift Register) from which no data are extracted has this property. An LFSR is thus an entropy memory.

If the noise quality of the physical noise source 10 is no longer optimal subsequent to filling the entropy memory 12, for instance, because of an attack, then the entropy memory 12 is successively emptied with bit extractions, so that the entropy of the extracted bit stream appreciably decreases only after an adjustable number of bits. The adjustable number of bits is defined by the capacity of the entropy memory. As represented in FIG. 1, the entropy memory 12 is inserted behind the physical noise source 10 such that the input of the memory 12 is connected to the output of the noise source. A feedback shift register can be utilized as the entropy memory.

In order to make it impossible to draw inferences about the output data of the noise source 10, a mathematical one-way function 14 is advantageously inserted behind the entropy memory 12. The input of the mathematical one-way function 14 is obtained from the output of the entropy memory 12, and the output of the mathematical one-way function 14 provides the useful data.

A one-way function is a mathematical function that can be easily calculated in one direction, but which is very difficult to invert. For instance, a cryptographic hash function can be utilized as a one-way function. In contrast to hash functions, LFSRs are not one-way functions, because they are easy to invert.

In principle, in the above exemplifying embodiment, the output of the entropy memory 12 can no longer be accessed from outside following the insertion of the one-way function 14. By this measure, the invention guarantees with certainty that an attacker of the physical noise source cannot receive any information about the internal condition of the physical noise source. For this reason, it is unadvisable to implement the one-way function as software, because access to the output data of the entropy memory 12 could not then be eliminated.

Regardless of an attack from outside, physical noise sources undergo sharp fluctuations of performance as a consequence of fluctuations of fabrication technology. A further object of the invention is to be able to set this performance of the noise source to a constant value without degrading the quality of the noise data. The entropy memory 12 connected to the physical noise source on the downstream side can serve this purpose as well.

As represented in FIG. 2, for the purpose of achieving a constant performance of the noise source, the entropy memory 12 is driven with a constant clock cycle that is independent of the noise source and that has a frequency corresponding to the desired value. The performance of the noise source 10 must be greater than this desired value, so that the bit stream that is extracted from the entropy memory 12 has an entropy greater than or equal to the entropy of the noise source.

Of course, the measures described in FIG. 1 and in FIG. 2 can also be combined, so that the entropy memory 12 is clocked with a frequency that is independent of the noise source, and in addition a one-way function 14 is connected to the entropy memory on the downstream side.

I claim:

1. A device for increasing an operating reliability and constancy of a noise source having an output, the device comprising:
an entropy memory for connection to the output of the noise source, said entropy memory having an output; and
a hard-wired one-way function connected directly to said output of said entropy memory.

2. The device according to claim 1, wherein: said entropy memory is a feedback shift register.

3. The device according to claim 1, wherein: said one-way function is a cryptographic hash function.

4. The device according to claim 1, wherein: said noise source has a performance; and said entropy memory is read with a constant frequency that is lower than said performance of said noise source.

5. A method for increasing an operating reliability and constancy of a noise source, which comprises:
buffering output values of the noise source to obtain buffered output values; and
immediately following the buffering, converting the buffered output values of the noise source using a hard-wired mathematical one-way function.

6. The method according to claim 5, which comprises: using a feedback shift register to perform the buffering of the output values of the noise source.

7. The method according to claim 5, which comprises: using a cryptographic hash function as the one-way function.

8. The method according to claim 5, which comprises: further processing the buffered output values of the noise source at a constant clock cycle that is lower than a performance of the noise source.

9. The method according to claim 5, wherein: the output values of the noise source cannot be accessed.
